(19) United States
(12) Patent Application Publication
(10) Pub. No.: US 2004/0032424 A1
(43) Pub. Date: Feb. 19, 2004

(54) Method and system for producing and administering a web-cast event

(76) Inventor: Alan Scott Florschuetz, Allen, TX (US)

Correspondence Address: Ian DiBernardo, Stroock & Stroock & Lavan, 180 Maiden Lane, New York, NY, 10038, US

(21) Appl. No.: 10/415,547

(22) PCT Filed: Nov. 6, 2001
(86) PCT No.: PCT/US01/47058

(51) Int. Cl. G09G 5/00

(52) U.S. Cl. 345/748

(57) ABSTRACT

A system and method for providing a graphical, development interface through which clients can develop a web-cast event, including a multi-media web-cast player. The system and method also dynamically generating the web-cast player using the selections of the client. During the development process, the client selects various user perceptible attributes for the web-cast player, uploads and manages content, schedules and creates events and otherwise manages the development and production of web-cast events. Production software operating on a server system remote from the client dynamically generates the web-cast event and communicates the event to a plurality of end users, who interact with the player.

### CROSS-REFERENCE TO RELATED APPLICATIONS

This Application claims priority to U.S. Provisional Application Serial No. 60/268,514, filed on Feb. 13, 2001.

### FIELD OF THE INVENTION

The field of the invention relates to the transmission of interactive web-cast events and, in particular, to a method and system for producing a custom web-cast event.

### BACKGROUND OF INVENTION

Generally speaking, web-casting (or Internet broadcasting) is the transmission of live or pre-recorded audio or video to personal computers or other computing or display devices that are connected to the Internet or other global communications networks. Web-casting permits a content provider to bring both video and audio, similar to television and radio, directly to the computer of one or more end users in formats commonly referred to as streaming video and streaming audio. In addition to streaming media, web-cast events can be accompanied by other multimedia components, such as, for example, slide shows, web-based content, interactive polling and questions, to name a few.

Web-cast events can be broadcast live or on played back from storage on an archived basis. To view the web-cast event the end user must have a streaming-media player, such as for example RealPlayer™ (provided by Real Networks™, Inc.) or Windows® Media Player (provided by Microsoft® Corporation), loaded on their computing device. Furthermore, as set forth above, web-casts may include other multimedia content such as slides, web content and other interactive components. Thus, in general, end users also will need at the very least a web browser, such as Netscape Navigator or Microsoft Internet Explorer.

Currently, the production of a web-cast event is a largely manual procedure, which is both time consuming and costly. In general, the streaming video or audio is stored on a centralized location or source, such as a remote server, and pushed to an end user's computer through the media player and web browser. When the end user clicks a web link associated with the streaming content, a media player is launched and the streaming content is delivered to the end user's computer. To combine the streaming content with other interactive content, such as a slide presentation, a customized player could be developed. Customized players known in the art, however, are generally hard-coded by programmers and are usually time consuming to update or modify. To date, web-cast events have been broadcast in many different forms. For example, a single interface might be developed in which all of the components of the web-cast are incorporated. In turn, independent “windows” could be used to deliver the various components of the web-cast. For instance, a developer could program a single interface to deliver the components of the web-cast event. For example, rather than delivering the streaming video in a standalone media player, a client might prefer to embed the player in a web page. In such instances, the controls which operate the embedded player's functionality would need to be custom developed and coded. Furthermore, the other content components of the web-cast (such as slides, interactive polls, chat boxes, etc.) would also need to be custom developed and integrated into the presentation. The process of creating this type of web-cast is and has been, to date, labor intensive and costly.

Similarly, the use of slides requires time consuming manual integration and timing. In the case of slides, it is often desirable to time the rotation of slides at various points during the streaming content. Currently, not only must a developer integrate the slide presentation into the web-cast, but must manually synch the slides to the streaming content.

Live web-cast events are also known in the art. Presently, however, live web-cast events are limited to the features built-in prior to the start of the broadcast. Thus, if an interactive poll is created during a live event in response to end use behavior, there is no efficient mechanism for pushing it to the end user during the live event. As such, valuable opportunities to collect information from end users may be lost.

There are also no efficient development tools available to the client that give the client the control to upload content and incorporate that content into a client built web-cast player. Moreover, there are no efficient development tools that collect the client's design settings and dynamically generate the web-cast player. Yet further, no efficient development tool exists that allows clients to modify or update existing web-casts and dynamically incorporate such modifications.

Consequently, there is no comprehensive system or process for producing a media rich and fully interactive web-cast event, which avoids the manual labor involved in coding the end user interfaces and interactive features and allows clients to manage, update, and enhance web-cast events both pre-event during the development stage and during broadcast.

Thus, there is a long felt need and desire for a system and method of developing and administering a web-cast event in a comprehensive and efficient manner.

### SUMMARY OF THE INVENTION

The present invention overcomes shortcomings of the prior art. According to a preferred embodiment of the present invention, a system and method of producing a web-cast for viewing by one or more end users generally comprises providing access to a centralized server system operative with production software through which a client (or web-cast producer) designs and manages an interactive web-cast event in an efficient and cost effective manner.

A method for design and production of a web-cast player having user-perceptible attributes defined by a group of design properties, the method comprises: (a) allowing a client to select a value for at least one of the user-perceptible attributes of the web-cast player; (b) mapping each of the selected values to a corresponding one of the design properties; and (c) generating the web-cast player using the mapped design properties and values. Generally speaking, the user-perceptible attributes correspond to graphical and interactive features of the web-cast player. In an exemplary embodiment, the step of mapping each of the selected values to a corresponding one of the design properties comprises storing the values in a data structure associated with the design properties. Furthermore, the step of allowing the client to select a value for at least one of the user-perceptible attributes comprises displaying a graphical interface on a client system.

A system according to an exemplary embodiment of the present invention comprises a centralized system for enabling a plurality of clients to each design and produce a web-cast event, wherein the web-cast event includes content and a player having user-perceptible attributes defined by a group of design properties through which the content is delivered, comprises a server system communicatively connected to the clients and to a plurality of end users via a network, the server system being operative with software to allow each of the clients to:

create an event directory for each web-cast event on the server system, the web-cast event being associated with a unique event identifier;

upload content for the web-cast event; and

select values for at least a portion of the user-perceptible attributes of the player; and

and the server is further operative to:

receive the selected values;

map the selected values to a corresponding one of the design properties; and

store the mapped design properties and values in the appropriate event directory.

In general, a server system is interconnected to the computing device of the client through a global communications network, such as the Internet. The server system allows a client to design a customized web-cast player by selecting various values the user-perceptible attributes of the web-cast player. The user-perceptible attributes are defined by a group of design properties that are mapped to the client's valve selections and used to generate the player. In the case of a live event, the client can design a new web-cast player to broadcast the live content. Archived events and players can also be updated or modified. Upon completion of the design process, the server system receives the values, which are mapped to corresponding design properties system and stores the vales in a hierarchical data structure. Each sub-directory of the data structure corresponds to a particular user-perceptible attribute of the web-cast player. The server system then processes the design properties and values to dynamically generate the player, which is an interactive end-user interface capable of broadcasting the event.

In particular, a client desiring to produce a web-cast accesses the production software stored on the server system through the Internet. Using the production software, the client is led through a series of steps during which the client inputs elects and sets the design properties for the web-cast. For example, a client can include a variety of interactive functional features in the web-cast, including but not limited to flash introductions, pushed or user driven slides, interactive questions, and interactive polls. Other functional features, such as registration customization, and embedded media players, and the graphical skin development are used in the generation of the web-cast and are controlled and/or selected by the client through the production software. For instance, the client can select from a variety of pre-developed skins which control the graphical features of the player. The client has complete control over the type of features incorporated and can easily modify the web-cast's user-perceptible attributes, even during the broadcast of a live event. In this way, as will be described in more detail below, a client can develop a media and content rich, interactive web-cast event in a comprehensive and cost efficient manner.

At any time during the design process, the client can push content to the server system to be included in the event. Content includes various types of media such as, by way of non-limiting example, streaming video or audio, graphical slides, Macromedia® Flash® or Shockwave® content, HTML documents, or other types of web-based content. The entire web-cast can be choreographed during the design process or synchronized during broadcast of the live event. In other words, pushed slides and streaming content, for example, are automatically synchronized each time a new slide is pushed to an end user by the production software. This is preferably accomplished by encoding a reference to the content into the stream. As such, the sequenced event is available for archived (or on-demand) playback almost immediately after the live web-cast event has ended. The client can also administer live events by creating and pushing other web-cast components during the live presentation. Thus, the client can create new interactive features on the fly. For example, using the question manager feature of the present invention, the client can push an interactive question to end users during the live presentation or field questions from end users. Any number of different types of interactive features can be included in the production software.

Once the process of selecting the values for the user-perceptible attributes and uploading the media content is completed, the values and corresponding design properties are processed by the server system to generate an interactive, graphical user interface (GUI) to deliver the event content to the end user. In other words, the actual HTML, DHTML, CSS, JavaScript, programming code necessary to deliver the interactive, multimedia web-cast event with a customized look and feel to a plurality of end users, such or for example the actual HTML, DHTML, CSS, JavaScript and/or other code or scripts, is dynamically generated by the server system using the design properties selected by the client. Generally speaking the production software makes a call for each valve and design property as it is needed to generate the web-cast player. When the client changes a valve, the change is reflected by replacing the original valve with the changed valve. Thus, each time the production software makes a call for the values, the desired change in the web-cast player is incorporated.

In this way, the client is given complete control over the web-cast event and can administer and manage all of the various components of the web-cast event from end-to-end. Moreover, the various embodiments of the present invention provide a centralized system for receiving values associated with the user-perceptible attributes of the web-cast player thereby enabling a plurality of clients to each design customized web-cast players through which their content is delivered to end users. When the content is requested by an end user the system dynamically generates the player. Yet further, the various embodiments enable clients to administer, update, and enhance both live and archived events through a centralized system.

Other objects and features of the present invention will become apparent from the following detailed description, considered in conjunction with the accompanying system schematics and flow diagrams. It is understood, however, that the drawings, which are not to scale, are designed solely for the purpose of illustration and not as a definition of the limits of the invention, for which reference should be made to the attended claims.

### BRIEF DESCRIPTION OF THE DRAWINGS FIGURES

In the drawing figures, which are not to scale, and which are merely illustrative, and wherein like reference numerals depict like elements throughout the several views:

FIG. 1 in accordance with the present invention;

FIG. 2 is a schematic diagram of an overview of an exemplary embodiment of a content management system in accordance with the system of FIG. 1;

FIG. 3 is a schematic diagram of the components of the production software in accordance with an exemplary embodiment of the present invention;

FIG. 4a is a screen shot of an graphical interface displayed on a client system for allowing the client manage content;

FIG. 4b is a screen shot of a further graphical interface displayed on a client system for allowing the client manage content.

FIG. 5 is a screen shot of an exemplary interactive, multimedia web-cast player in accordance with an exemplary embodiment of the present invention;

FIG. 6 is a schematic diagram of a data structure in accordance with an exemplary embodiment of the present invention;

FIG. 7 is a flow diagram of an exemplary process for dynamically generating the web-cast player of FIG. 5 and delivering an event;

FIG. 8 is a flow diagram of a process for dynamically incorporating events into a live web-cast;

FIG. 9a is a screen shot of an exemplary embodiment of a development interface illustrating use of an event wizard;

FIG. 9b is a screen shot of an exemplary embodiment of a development interface illustrating the scheduling of a web-cast event;

FIG. 9c is a screen shot of an exemplary embodiment of a development interface illustrating another aspect of the scheduling of a web-cast event;

FIG. 9d is a screen shot of an exemplary embodiment of a development interface illustrating selection of functionality to add to a web-cast event; and

FIG. 9e is a screen shot of an exemplary embodiment of a development interface illustrating use of a registration form builder.

### DETAILED DESCRIPTION OF THE PRESENTLY PREFERRED EMBODIMENTS

There will now be shown and described in connection with the attached drawing figures a preferred embodiment of a system and method for producing and administering a web-cast event. As used herein, the term “web-cast event(s)” generally refers to the broadcast via a global communications network of video and/or audio which may be combined with other multimedia content, such as, by way of non-limiting example, slide presentations, interactive chats, questions or polls, and the like. Furthermore, the term “web-cast player” generally refers to an interactive end user interface having various embedded or layered windows and controls through which media content is delivered to the end user's computer. The term “user-perceptible attributes” generally refers to the graphical and functional features of the web-cast player.

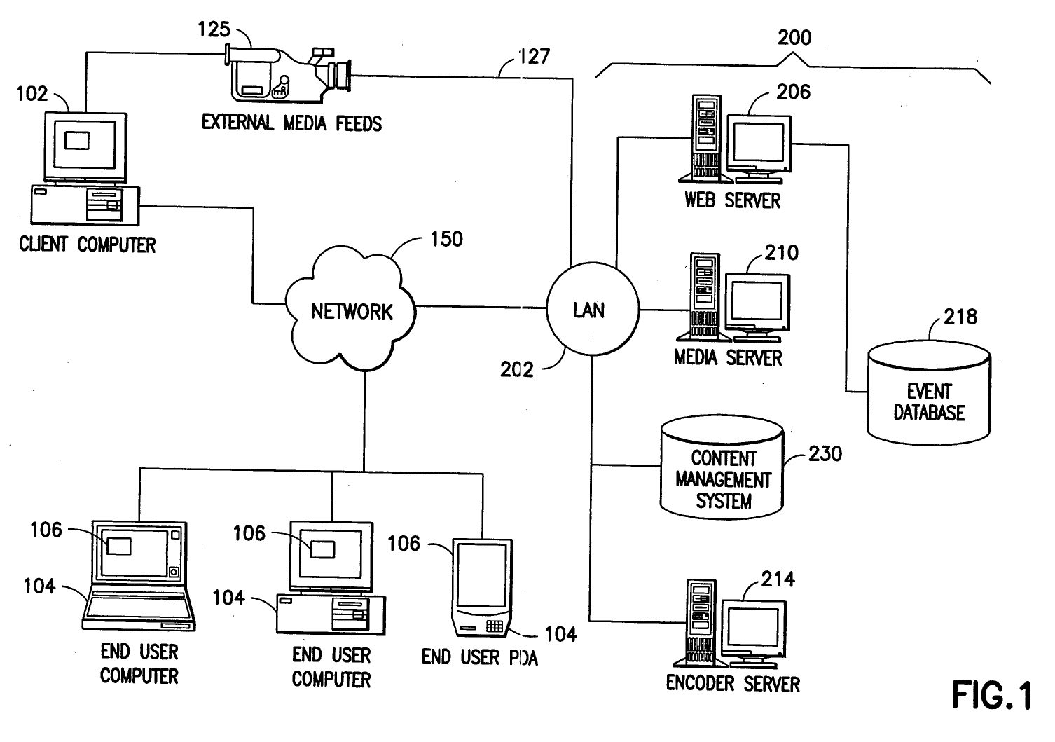

With reference generally to FIGS. 1-9a-e, there is shown a preferred embodiment of a system and a method of generating a web-cast event. In general, the system 200 allows for the end-to-end development and management of one or more live or archived web-cast events by a plurality of clients. In particular, a client interacts with production software 300 stored on a web server 206 via the Internet or other computer-to-computer network 150 that permits the client to design and select the various user-perceptible attributes 501 of the web-cast player 500. Each of the attributes is defined by a group of pre-defined design properties 630 that, upon completion of the development stage, are mapped with values selected by the client. The server 206 captures the values and stores them in a client account 605 on an event database 218, as described further below. In this way, the design properties 630 are mapped to corresponding values that are utilized by the production software 300 stored to generate the web-cast player 106 and deliver the web-cast event. Because the design properties 630 control the look and feel and operation of the web-cast player 106, clients can enhance, change, or update the web-cast player 106 by simply modifying the associated values for the design properties 630. As will be described in more detail below, updated content can be pushed to the web-cast player 106 during a live event and incorporated into the web-cast event in real-time.

Overview of the Preferred System Architecture

Referring now to FIG. 1, there is shown a system architecture in accordance with a preferred embodiment of the server system 200 of the present invention. As will become apparent from the following discussion and the associated figures, both the client and the end users have computers 102 and 104, such as PCs, coupled to a global communication network 150, such as the world wide web or Internet, by any one of a number of known manners. Furthermore, each client system 102 includes an Internet browser such as Internet Explorer or Netscape Navigator. Additionally, each end user system 104 includes an Internet browser, such as Internet Explorer or Netscape Navigator, and a media player, such as Windows Media Player or Real Networks RealPlayer. It should be noted, however, that although the present embodiment is described in connection with Windows and Real Networks media formats, it is within the scope of the present invention to utilize any audio visual media display format or system hereto or hereafter known or developed.

Furthermore, while the client systems and end user systems 102, 104 are coupled to each other and to the server system 200 via the Internet or other global communication network 150, the components of the server system 200 are coupled to each other via a communication network such as a local or wide area network (LAN or WAN) 202. More specifically, a web server 206, encoder server 214, media server 210, content management system 230, and associated event databases 218, are all in communication via a secure network such as a LAN 202. It should also be noted that although the present embodiment utilizes separate servers for various functions of the server system 200, other embodiments could be implemented by storing software on a single server or any combination of multiple servers to perform the functionality described herein.

In addition to the client systems and end user systems 102, 104, external media feeds 125 are coupled to the server system 200 either through the communications network 150 or through the client systems 102 in combination with the communications network 150. It will be understood that external media feeds 125 may include any source of video or audio, including but not limited to analog or digitally recorded video/audio, broadcast video/audio (whether by satellite, cable, or airwaves), and the like. It will also be understood that network 150 is any global communications network, including but not limited to the Internet, a wireless/satellite network, cable network, and telephone network, to name a few. As shown in FIG. 1, in a preferred embodiment, for security and reliability purposes, external media feeds 125 are preferably connected to LAN 202 via a separate communications line 127 (i.e., a private, direct wireless/satellite, cable, or telephone connection).

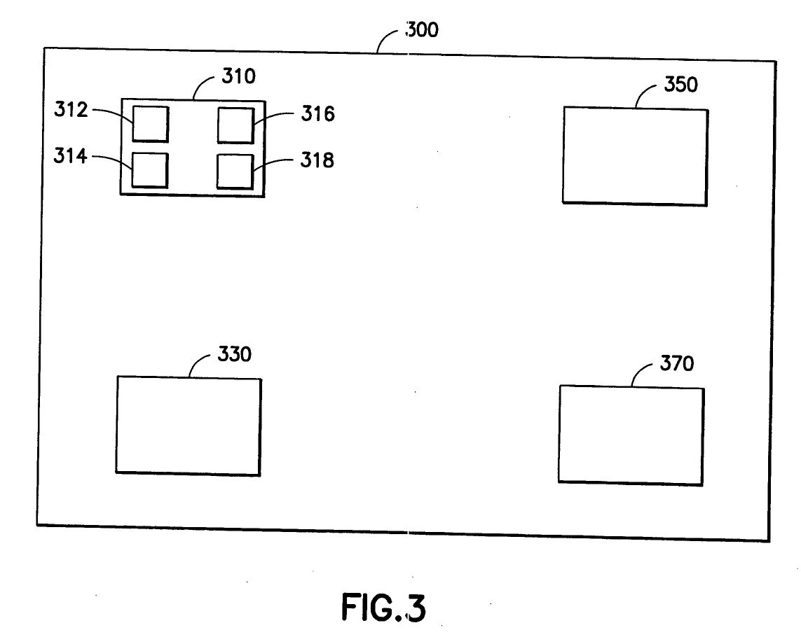

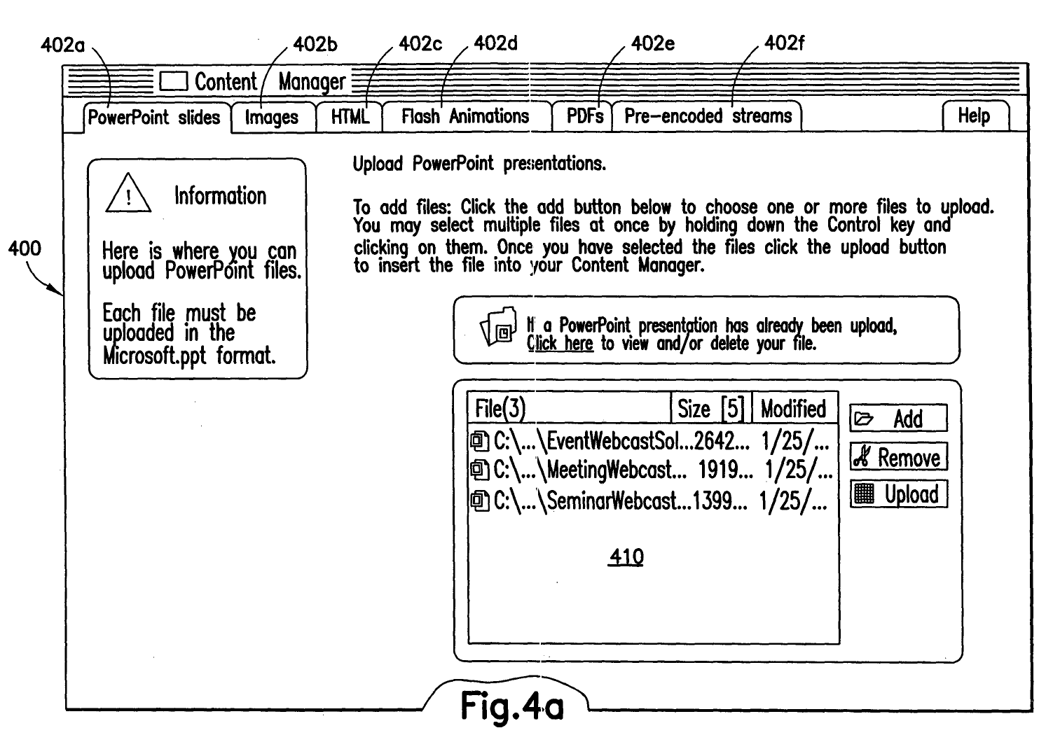

As will be described below, the web server 206 is programmed with production software 300 (FIG. 3) to enable clients to design, produce, and administer web-cast events. It is to be understood that, as used herein the term “production software” refers generally to a server-side application such as for example, CGI scripts, Active Server Pages (ASP), servlets, Internet Server Application Program Interfaces (ISAPI), and the like. In addition, one skilled in the art will recognize, that although a server-side application is preferred, the production software 300 could be stored and driven wholly on the client-side so long as the design properties 630 are communicated to the server-side 200 through the network 150. As will become evident from the following description, the production software 300 when executed on the server-side 200 of the client-server architecture preferably permits clients to rapidly and efficiently produce web-casts.

The production software 300 bundles any number of interactive features that can be incorporated into the web-cast player 106, including but not limited to embedded video windows, synchronized data windows, embedded browser windows, and any other media windows that may hereafter be developed. It is to be noted that the type of media incorporated into the web-cast player 106 is not critical to the subject invention.

In addition to the above, as will be described further below, the production software 400 permits the client to merge content into a live event. The production software also allows clients to enhance the interactivity of the web-cast events, collect valuable end user feedback, and track the results of the web-cast. These interactive tools include, but are not limited to, self reporting functions, presentation managers, question managers, and polling managers. By combining all of these tools and functionalities into a single client development tool, the client is given complete control over the production and administration processes to produce and deliver web-casts in a rapid and cost efficient fashion. Moreover, the ability to merge content into live streams allows the client to produce multimedia events that are available for archived replay almost instantly after the live event has ended. Further, it is to be understood that the various features described herein are merely illustrative and any number of features can be incorporated in the manner described herein.

With further reference to FIG. 3, an exemplary embodiment of the production software 300 comprises a development component 310, a generation component 330, a live event administration component 350, and a reporting component 370. Further, the development component 310 comprises various sub-components, including a content management component 312, a scheduling component 314, a presentation preparation component 316, and a channel component 318. Each component 310, 330, 350, and 370 and sub-components 312, 314, 316, and 318 is a module of the production software 300 that operates and controls the various functions of the production software 300 described herein. One skilled in the art will recognize that although the functionality of the production software 300 is described herein in terms of components, the production software 300 can be developed in any manner that performs the disclosed functionality. Preferably, the production software 300 utilizes an object oriented programming language, such as for example, Visual Basic, C++ and/or Java. In this way, objects can be created for each feature of the web-cast. The objects, as with other object oriented programs, include both data and functions.

Although not depicted in the figures, the servers 206, 210, and 214 generally include such art recognized components as are ordinarily found in server systems, including but not limited to processors, RAM, ROM, clocks, hardware drivers, associated storage, and the like. One skilled in the art will recognize that the server system may as a matter of design choice include any number and configurations of servers and databases, which may be used separately or in tandem to support the traffic and processing needs necessary in operation at one time. In the preferred embodiment, the web-servers 206 and media servers 210 are configured using a round-robin configuration to handle end user traffic.

Furthermore, each of the systems and servers described herein include a network connection (not shown). The network connection may be a gateway interface to the Internet or any other communications network through which the systems can communicate with other systems and user devices, as shown in FIG. 1. Network connection may connect to the communications network through use of a conventional modem (at any known or later developed baud rate), an open line connection (e.g., digital subscriber lines or cable connections), satellite receivers/transmitters, wireless communication receivers/transmitters, or any other network connection device as known in the art now or in the future.

Client and end user systems 102, 104 preferably include, by way of non-limiting example, a storage device, processor, display device, input device, and network connection (not shown). In general, client and end user systems 102, 104 are personal computers or net appliances capable of accessing and interacting with the servers of the web-cast generation system 200. In addition, the client and end user systems 102, 104 can be any other portable communication device such as a Personal Digital Assistant (PDA), wireless or wired telephone, and other hand-held computing devices. Although not shown, client and end user systems 102, 104 also include such other components as are ordinarily found in such systems, including but not limited to RAM, ROM, clocks, hardware drivers, software and the like.

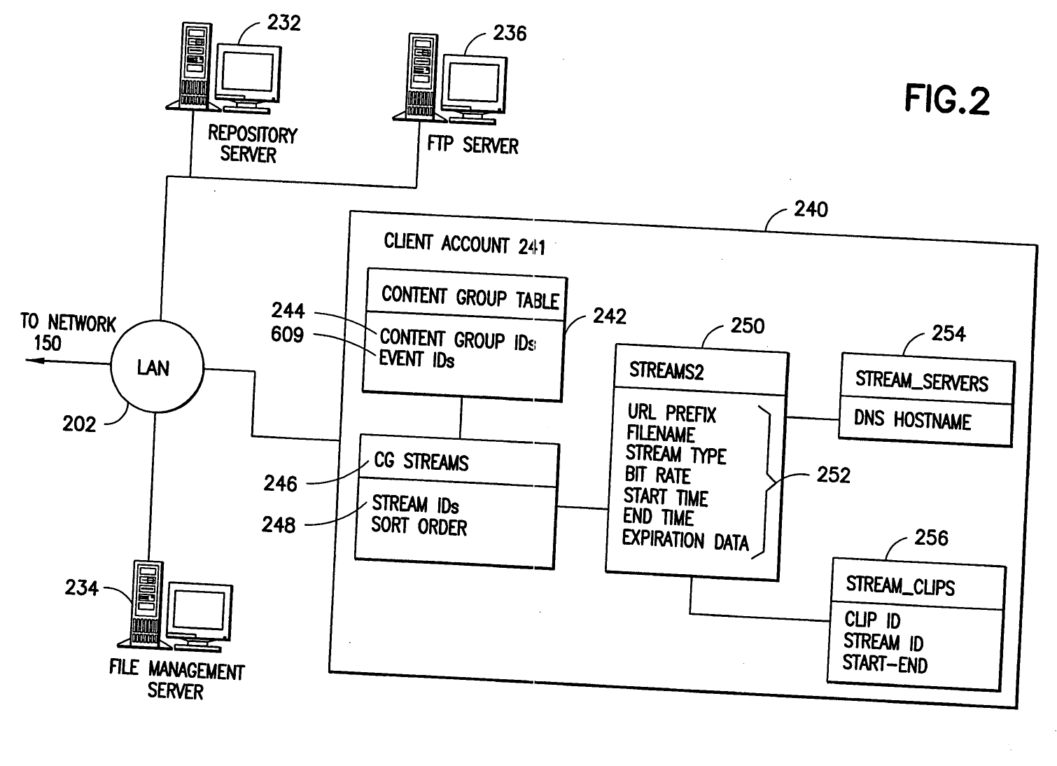

With further reference to FIG. 2, a preferred embodiment of a content management system 230 for storing and categorizing content uploaded by clients is shown. Although the upload of content to the content management system 230 is the logical first step in producing a web-cast event, it is to be understood that the method and system of the present invention is freeform and the client can produce the web-cast in any order.

In general, the content management system 230 allows clients 102 to upload streaming and non-streaming media content to the system 230, manage such content, and make content available to be delivered to end users through the web-casts player. As discussed in greater detail below, the client 102 uploads the media content to the repository server (and associated storage) 232 either directly, via an HTTP upload, or via an FTP ingest server (and associated storage) 236. Once the client has uploaded its streaming media content, the client may manage its content via web pages on a content management web site provided by web server 206 (shown in FIG. 1). Although not critical to the present invention, the client can manage the media content stored on the client's account. It will understood that one or more content management systems can be utilized to upload, store and manage content. By way of non-limiting example, one system may be used to manage streaming content, while another is used to manage non-streaming content.

With reference to FIGS. 1 and 2, central to the content management system 230 is the Content Management (CM) Database 240. The CM Database 240 includes numerous relational Databases. In general, the CM Database 240 includes account information, which identifies each client's account 241, stream information 250, which identifies and describes each item of streaming content within a client's account, playlist information (shown in FIG. 2 as the Content Group Table 242), which identifies and describes each client's playlist, and storage location information (shown in FIG. 2 as the Stream-servers Table 254), which tracks the storage of content on the streaming media servers 210 (shown in FIG. 1).

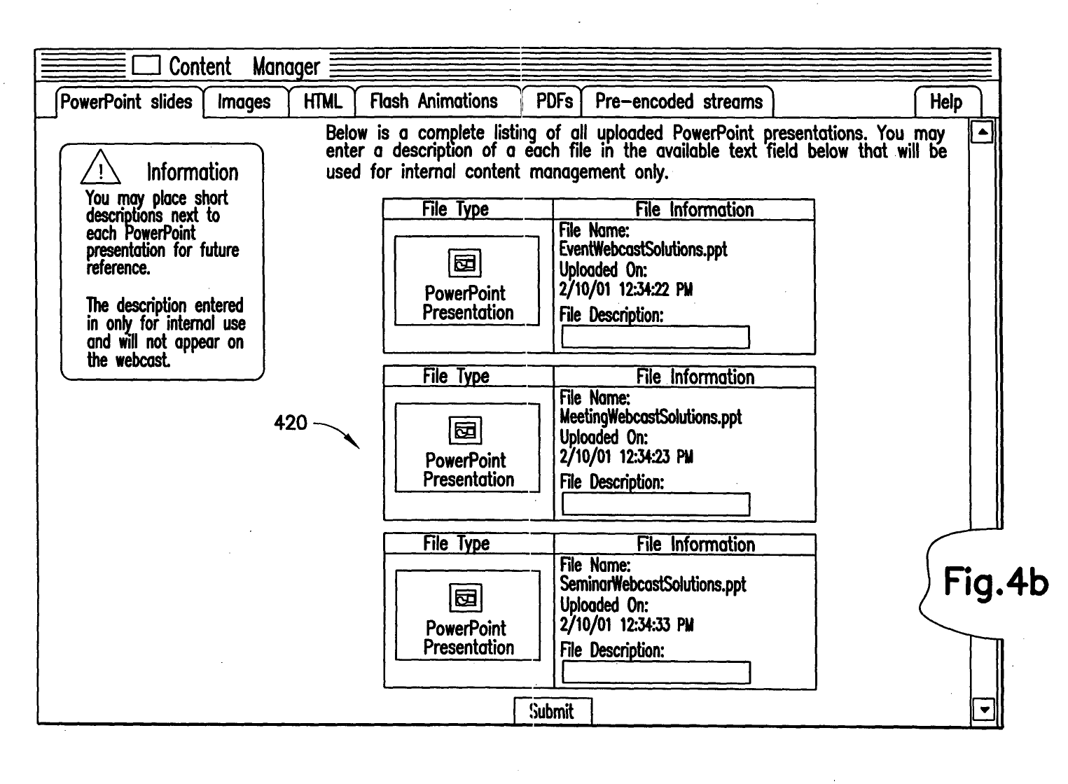

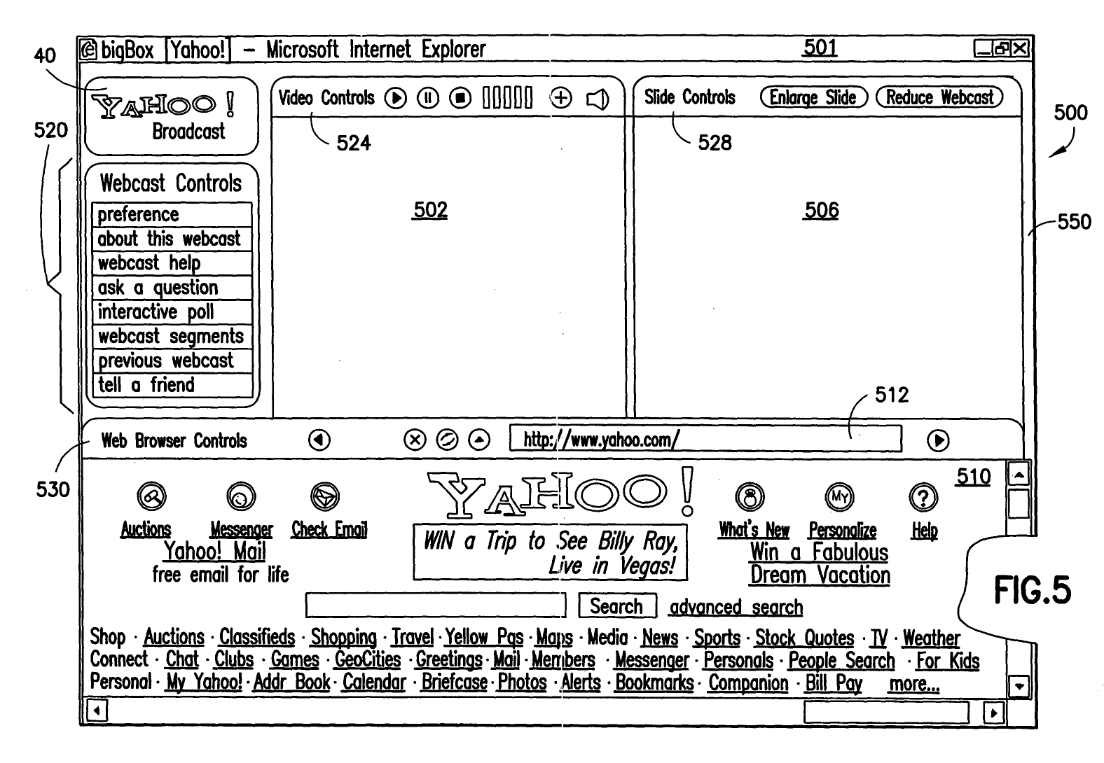

Using the content management component 312 of the development component 310, the content management system 230 also allows the client to manage and store slide images, HTML pages, Flash animation, PDF files, and pre-encoded streams. The client preferably interacts with the content management system 230 through a graphical interface 400 displayed by the development component 310 of the production software 300, as shown in FIGS. 4a and 4b. The content management functionality 312 of the development component 310 permits a client to upload files, view lists of existing files, delete files and otherwise manage the content available for inclusion in a web-cast event. Various formats of streaming and non-steaming content can be uploaded including but limited to PowerPoint presentations, images in JPEG, GIF, or PNG formats, HTML pages, Flash animations, PDF files, and pre-encoded streams. Preferably, the client first selects to add an event series. By way of example only, an event series is generally a group of topically, related web-cast, such as a corporate training program, a series of “do-it-yourself” seminars, and the like. Once the event series is created, any number of events can be stored in an event series. Of course, multiple event series and multiple associated events can be stored by the system. Both the event series and the particular event are given unique identifiers, as described further below. The files uploaded to the content management system 230 will be available for all events within an event series.

In an exemplary embodiment, shown in FIG. 4a, a graphical development interface 400 includes a tab 402a-f for each type of content file that can be uploaded to the content management system 230. It, of course, is to be understood that the depiction and labels of tabs in FIGS. 402a-f is merely exemplary and not intended as a limiting or exhaustive list. Using the tabs, the client can choose the PowerPoint side tab 402a, for example, to upload any number of PowerPoint slides to the content management system 230. The client first selects the particular event series and event 901 (FIG. 96) with which the uploaded content will be associated. The client can then choose to add files to the content management system. A pop-up window will appear which allows the client to access the PowerPoint files on the client system that are to be uploaded to the content management system 230. Once the files are selected, they are added to a list 410 in the graphical development interface and can be uploaded at any time. Next, the client selects to upload any number of the listed slides and the upload process is begun. It will be noted that the manner in which the sides are uploaded from the client system to the content management system 230 can be performed in any manner including FTP, hypertext transfer (HTTP) protocol, and the like. With further reference to FIG. 4b, once the slides are uploaded, the client will be presented with a file information screen 420 which allows the client to enter a description for each file uploaded. Although this description is not necessary to the functioning of the system, such descriptions can enhance the ability of the client to manage the uploaded content. One skilled in the art will recognize that the same or similar process can be used to manage the other types of content described herein.

Under direction of the file management server 244, the uploaded streaming content is eventually transferred to the streaming media servers and associated storage 210, where it is available for streaming via the communications network 150. In turn, non-streaming content is preferably published to the web servers 206 once the event is completed and ready to go live. As described in greater detail below, the current embodiment utilizes a web server 206 (shown in FIG. 1) to dynamically generate a playlist metafile (such as ASX, RAM, SMIL, and RPM files, to name a few) to be provided to the end-user's windows media player. In addition to the archived content located on the streaming media server 210, the present environment provides for streaming of live content acquired via encoder servers 214 coupled to the streaming media servers 210. In this way, the location of the media content is delivered to the web-cast player, so that the end user can retrieve the content on-demand.

In a live event, an external media feed 125 (shown in FIG. 1) delivers content, such as for example a live NTSC television feed, into the server system 200 through LAN 202. The feed 125 passes first through the encoder servers 214, which have been configured to receive the feed 125 and encode it into a streaming media format (ASF, RAM, etc.). Through the LAN or WAN 202, the encoded media feed is communicated to the media servers 210. As will be discussed further below, the link (or URL) that the end user clicks to view the web-cast event includes an event identifier (or id) that is associated with the location of the streaming file on the media servers 210. As such, the streaming file can be delivered to the end user system 104.

Exemplary Embodiment of a Web-cast Player

With further reference to FIG. 5, there is shown an exemplary embodiment of the user-perceptible attributes or graphical features of a web-cast player 500. The exemplary web-cast player 500, shown in FIG. 5, includes three embedded media windows: a streaming video window 502, a slide window 506, and a browser window 510. It will be understood that the client may select any skin and layout type that includes the functionality and window layout that best serves the client's needs. Furthermore, it is to be understood that any number of data windows 502, 506, 510 can be embedded and positioned in the web-cast player 500. Moreover, pop-up windows (or layers) (not shown) can be used to add further media windows to the web-cast player 500.

Further, various interactive functional features are associated with each particular skin. In the exemplary embodiment, shown in FIG. 5, certain “Webcast Controls” 520 are provided, which include but are not limited to a “preferences” control, an “ask a question” control, an “interactive poll” control, a “webcast segments” control, and a “previous webcasts” control. Each of these controls 520 provide certain functionality to the end user and increases the stickiness of, and the end user's participation in the web-cast event.

The client can also choose to include pre-developed content into the web-cast. For instance, the client can select to have the web-browser window 510 link to a particular web page upon launch of the web-cast event. To accomplish this, the client enters a particular URL 512 into a home page field in the development tool.

Client Development

In an exemplary embodiment, with reference to FIGS. 1, 3, and 6, the server system 200 is operative with the scheduling component 314 and the presentation preparation component 316 of the development component 310 of the production software 300 to display a development interface (not shown) on the client system 102. Through the interface, the client is presented with a plurality of selections (e.g., check boxes, input fields, option boxes, drop-down menus, etc.) that allow the client to enter values 650 for at least a portion of the user-perceptible attributes 501 of the web-cast player 500 (shown in FIG. 5). The server system 200 operates with the production software 300 to capture and store the values 650 in the event directory 620 wherein the values 650 are associated with corresponding design properties 630. Because the server system 200 is centralized any number of clients can develop web-cast players and events in this way. The production software 300 then can dynamically generate a client-customized web-cast player for each client through which media content is delivered to the end user. In this way, the centralized production software 300 avoids the need to manually code individual web-cast players for each client.

As discussed above, although the client may interact with the development component 310 of the production software 300 in a freeform manner, the development process will be described in a logical order utilized by a development wizard that guides the client through the development process. The wizard process also prompts the client to include features not previously incorporated into the web-cast event. The wizard collects all of the values necessary to generate the web-cast player 500 and deliver the web-cast event to the end users. The wizard process further simplifies and automates the design process.

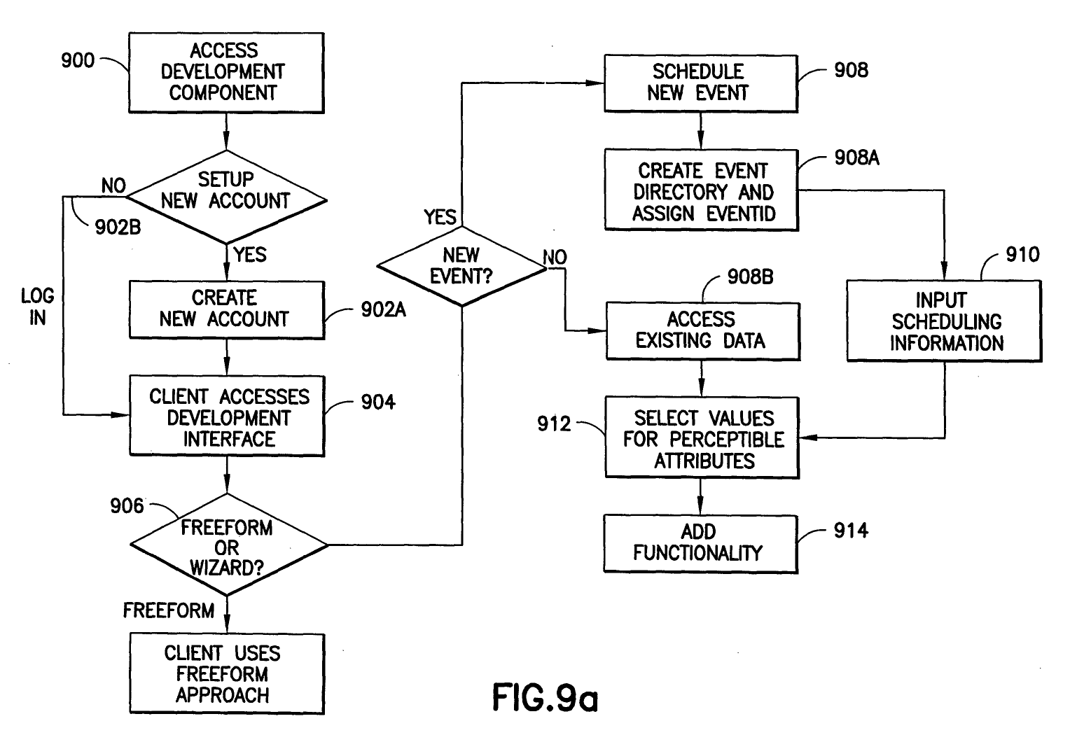

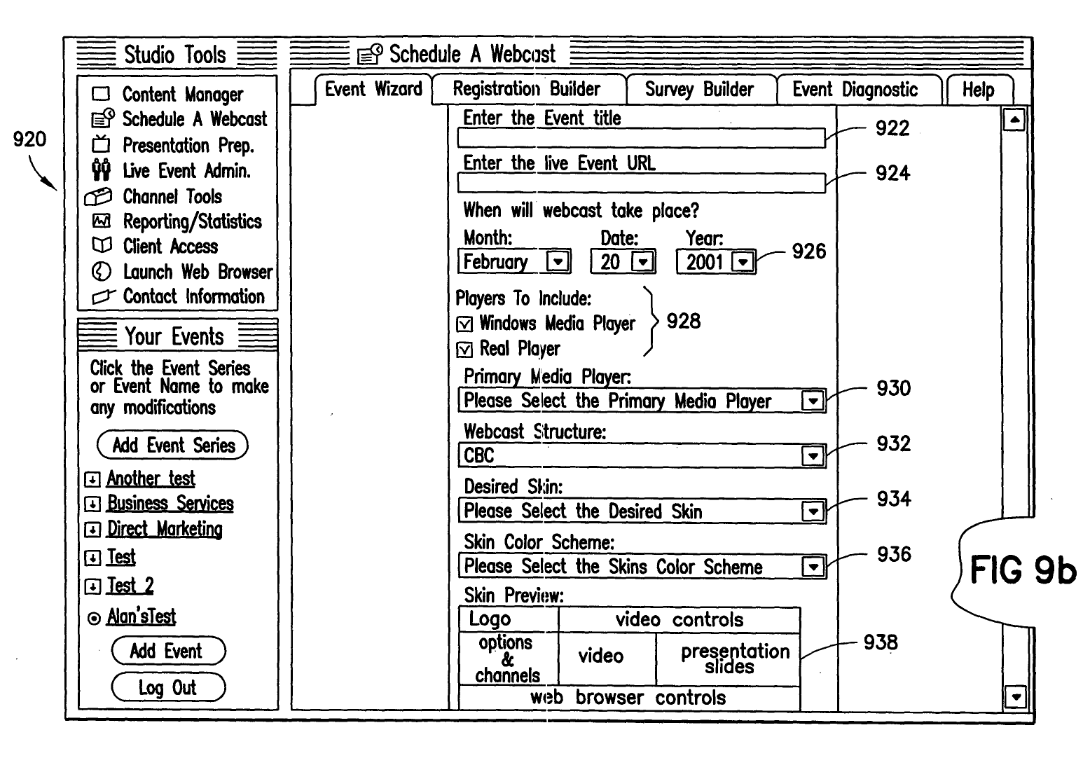

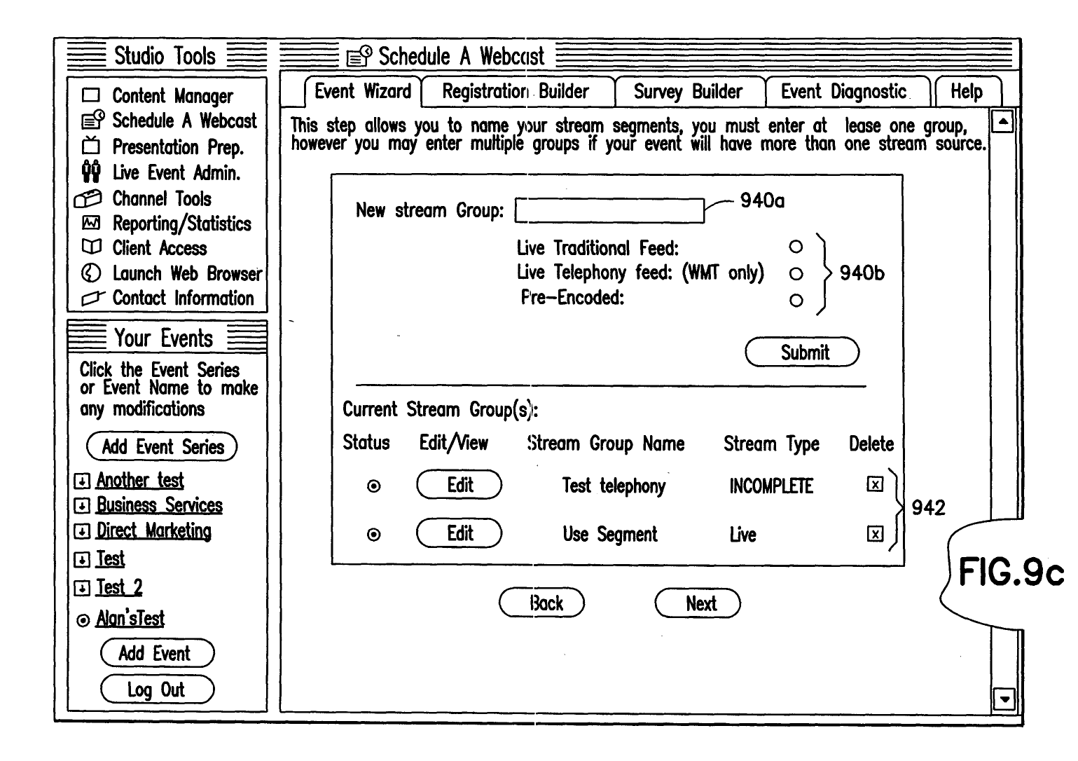

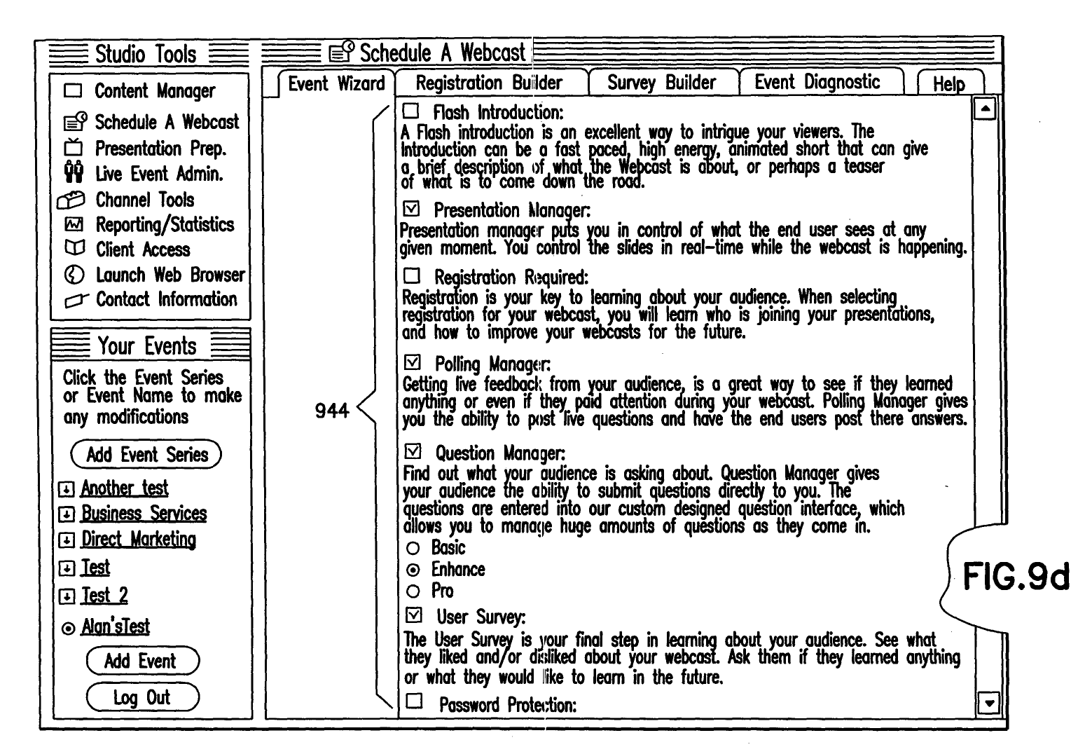

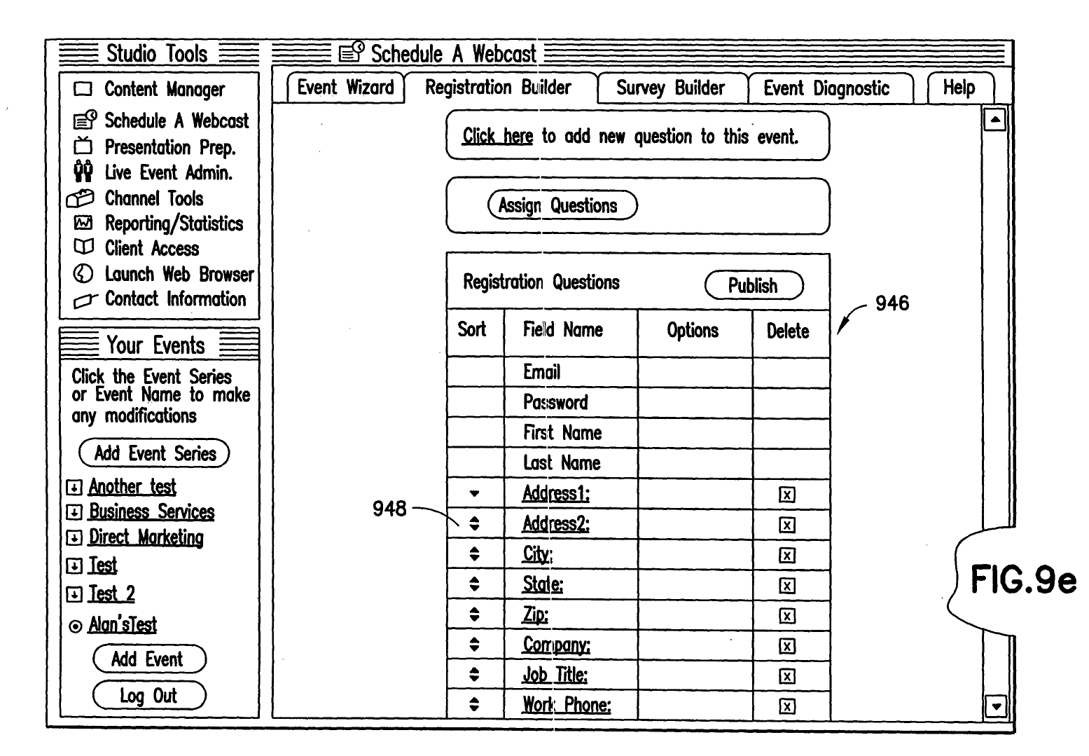

With reference now to FIGS. 9a-9e, there is a shown a preferred embodiment of the steps through which the client designs and produces a web-cast event using the development component 310 of the production software 300. The client first accesses the development component 310 of the production software 300 by establishing a communications connection through network 150. Step 900. If it is the first time the client is using the development component 310, then the client begins by creating a client account 605. Step 902A. The client account 605 is associated with the client's unique registration information, which may consist of a user name and password. If the client already has a client account 605, then the client can simply log in to establish a connection to the development component 310. Step 902B. With further reference to FIG. 2, the client account 605 is associated with client account 241 of the content management system 230, which stores pertinent information about the content uploaded by the client. Once access to the development component 310 is granted, the client is presented with the development interface 920 (shown in FIGS. 3b-3e). Step 904. At this time, the client can choose a freeform approach or the wizard approach. Step 906. As described above, the freeform approach is not described herein in detail, but essentially includes any process or order chosen by the client to develop the web-cast event using the development interface 420, including but not limited to the logical wizard approach described below.

The client preferably begins by creating and scheduling a new event or modifying an existing event. Step 908. For new events, an event directory 620 for the event is created in the client account 605 and associated with an EventID 609. Step 908A. It will become evident that the development component 310 is also utilized by the client to update and modify the user-perceptible attributes 501 of existing web-cast players 500. In the case of existing events, the values stored in the event directory 620 can be accessed and modified through the development component 310 of the production software 400. Step 908B.

Referring again to FIG. 9a, in Step 910, the client inputs scheduling information that is used by the production software 300 to prepare and configure the media servers 210 to handle the web-cast event. The process of configuring the media servers 210 is not critical to the present invention other than that a stream identifier (stream id) is preferably associated with a location of that content on a particular media server. The stream id will be used by the content management system 230 to dynamically generate a playlist metafile that is used by the web-cast player 106 on the end user's computer 104 to retrieve the appropriate stream files. This process will be described in greater detail below.

The client then preferably begins selecting the values for the user-perceptible attributes 501, including both graphical and functional features, for the web-cast player 106. Step 912. It will be noted that the following features may be incorporated by the client into the web-cast event, but are not necessary.

For each design property 630 a default value exists, that is used to generate the web-cast player 500 in the absence of values selected by the client. As such, the client can make selections for any portion of the group of user-perceptible attributes 501 of the web-cast player 500 and, therefore, a corresponding portion of the group of design properties 630. An exemplary set of design properties 630 is described further below.

Preferably, the client begins by selecting values for the graphical features of the web-cast player 500 interface and layout. In an exemplary embodiment, as shown in FIG. 5, the layout of the web-cast player 500 is embodied in a pre-developed build (or skin) 550. Each skin 550 has a unique look and feel and layout for the media windows 502, 506, 510. In addition, the skins 550 include various levels of functionality. The development component 310 permits clients to browse through and choose from a library of skins 550 for the web-cast player 500. These skins 550 can also be customized by choosing from color schemes and uploading logo or banner images that can be incorporated into the web-cast player 500. The client, therefore, is given complete control over the graphical features of the web-cast player 500.

The process of selecting the user perceptible attributes 501 (step 914 in FIG. 9a) using the graphical, development interface 920 will be described in connection with FIGS. 9b-9e. With reference to FIG. 9b, the client preferably begins by selecting an event from a list of events categorized by event series or by creating a new event in an existing or new event series. In the exemplary embodiment, the event series allows the client to create any number of events under a common event series theme. Once at least one event is added, the event wizard can be used to schedule the web-cast event and set the user perceptible attributes of the web-cast player, as shown in FIG. 9b. Preferably, the client selects an event title 922 and enters the live event URL 924, which links to the alias port on the streaming media servers 210. Furthermore, the client sets the date 926 the web-cast event will take place and can select which media players will be supported by the event 928 and the primary media player 930. Next, the client selects the web-cast player skin structure from a set of standard structures 932. A preview of the selected skin structure is displayed in area 938. Once the structure is selected, the client further selects the desired skin 934 and a skin color scheme 936.

With reference to FIG. 9c, the client then preferably creates stream groups to be included in the web-cast event. The client can create a new stream group 940a, which may include live feeds or pre-encoded feeds 940b, or manage previously created stream groups 942.

With reference to FIG. 9d, the client preferably selects the functional features 944 to be included in the web-cast event. As will be described further below, each of the features shown will define the user-perceptible attributes 501 of the web-cast player 500. The features 944 include but are not limited to Flash Introductions, presentation manager, registration, polling manager, question manager user survey, and password protection.

With reference to FIG. 9e, the client may then customize a registration form by adding questions to the form 946 or organizing existing form questions 948. As such, the client can customize a registration form (not shown) using the development component 310 that end users will be required to fill-out before access to the web-cast event is granted. Although the process of designing the form is not critical to the present invention, a brief explanation follows. The client preferably can choose to add any number of fields to the registration form, such as by way of non-limiting example, input boxes for the end user's first and last name, e-mail address, and other pertinent personal or business information. Furthermore, the registration form could include input boxes or check-type boxes to gather information regarding end user preferences as they might pertain to the web-cast event. For instance, if the web-cast event is directed to the launching of a particular movie, the registration form could ask for information regarding the types of movies that the end user generally goes to see. Thus, the registration form is the end user's gateway to the web-cast event and a useful tool for collecting end user information. Survey questions (not shown) may also be added to the registration form to increase the information gathered from end users.

Once the client completes the scheduling and development phase of the development process, the client is preferably presented with a diagnostic screen (not shown) that informs the client of the status of the web-cast event. The diagnostic screen serves to alert the client to potential problems or conflicts with the event or to remind the client to complete any missing information.

The functional features incorporated by the client are controlled by a processing component 350 of the production software 300. One skilled in the art will recognize that the processing component 350 is preferably a software module of the production software 300 that provides the functionality for the various functional features that may be included in a web-cast event.

As described above, these functional features may include, but are not limited to, question managers and poll managers. One skilled in the art will understand that various interactive, functional features not described herein can be coded into the processing component 350 and, therefore, incorporated into the web-cast player 500. An exemplary embodiment of a web-cast event that includes the question manager and poll manager functionality is described below.

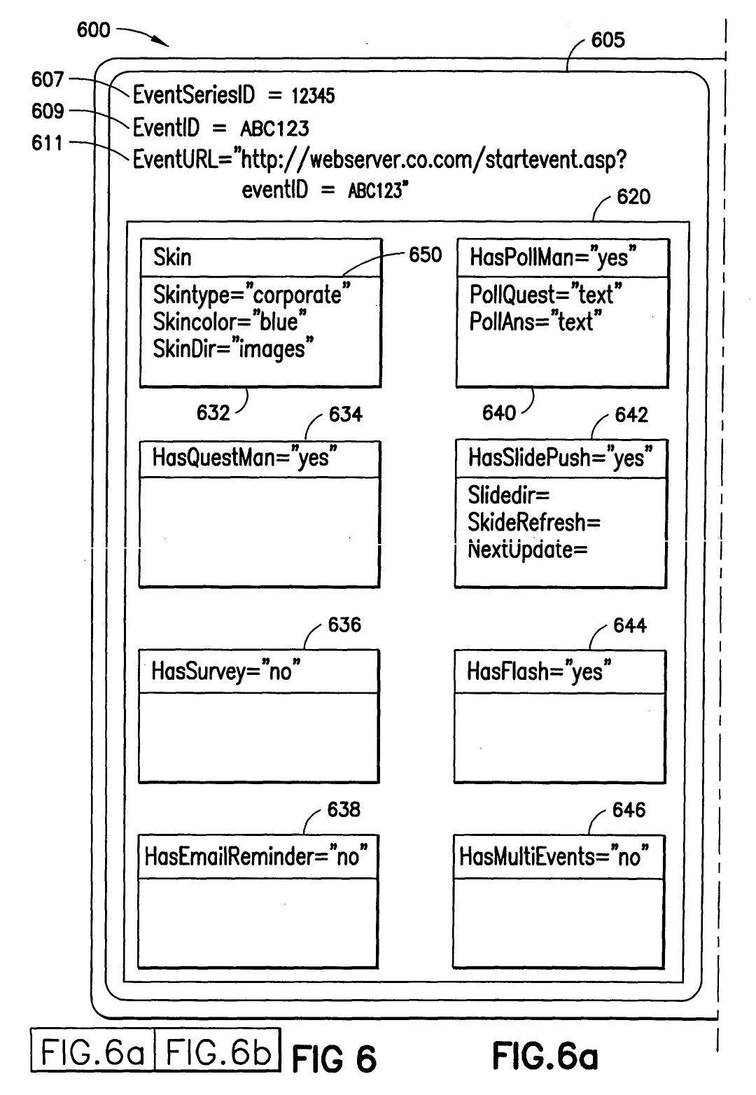

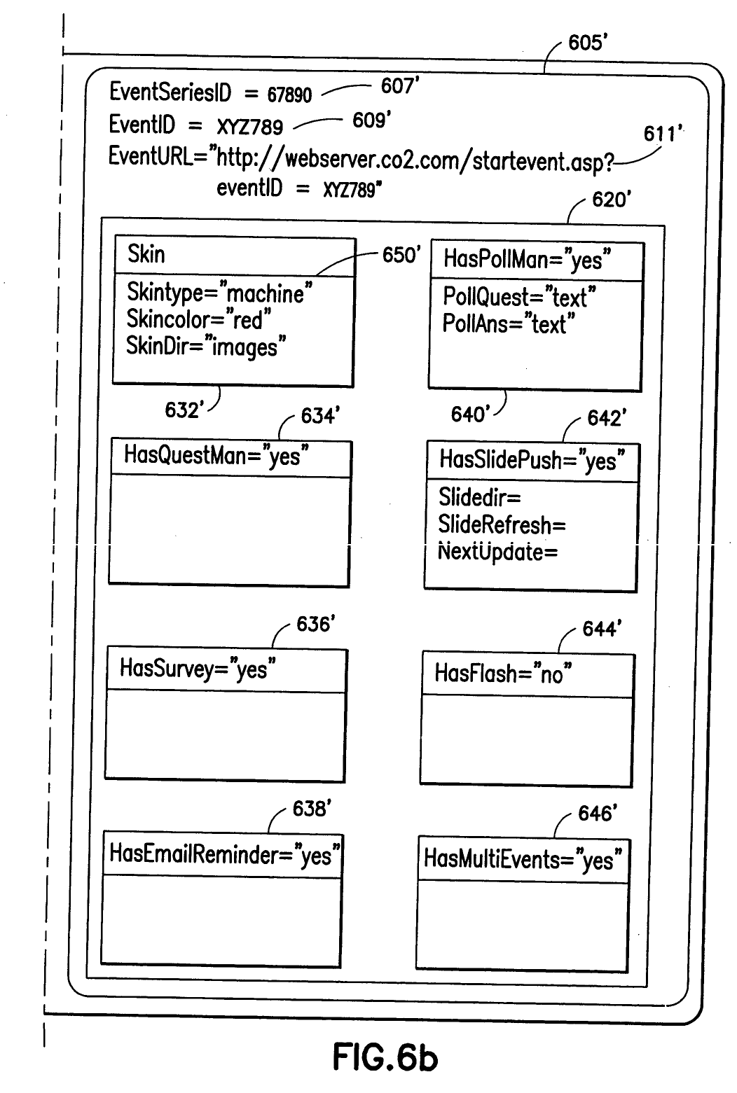

During development, the client can select to include a question manager feature through the development component 310 of the production software 300. The question manager allows the client to receive questions from end users and respond virtually in real time during the web-cast event. As shown in FIG. 6, the “HasQuestMan” property 630 has a client-selected value 650 of “yes”. This value indicates to the processing component 450 to include the question manager functionality in the web-cast player 500. In an exemplary embodiment, with further reference to FIG. 5, when an end user presses the “ask a question” control 520, a window or dynamic HTML layer (described further below) opens or is made visible in the web-cast player 500 allowing the end user to type a question which is transmitted to the web-cast administrator (or client). The client receiving the question can answer in real-time. The question manager can also be used to push quick facts or other information to end users.

Furthermore, using a poll manager feature, the client can create an interactive poll that can be delivered to the end user during the web-cast event. This interactive poll can either be created during the development process or pushed during the web-cast event. Generally speaking, when the “interactive poll” control 520 is clicked a layer window will appear in the player and will ask a question of end users and solicit an answer based upon multiple choices. Similar to the question manger functionality, the client's selection indicates a value 650 of “yes”, for example, which is mapped to the “HasPollMan” design property 630. This value indicates to the processing component 350 of the production software 300 to include the poll manager functionality in the web-cast player 500. In an exemplary embodiment, when the end users submits his or her choice, the poll manager calculates the current results of the poll and returns the results to the web-cast player 500 in a pop-up or layered window (not shown). It is to be understood that any format of an interactive poll can be used within the scope of the present invention.

The content management system 230 maintains an inventory of URL references to various content items, such as images, HTML pages, Flash content, and the like. Using the development component 310, the client can create an event script that is used during the web-cast event to push mini-events, as described further below. During this presentation phase, the client can use a data window template to create various HTML files based on certain data templates, including but not limited to a speaker intro template, bullet lists, URL redirects, speaker bios. After the client has created the desired files using the templates, they can be added to the event script. Once the event script has been created the client can delete files or reorder the position of the files. Other events such as polls and PowerPoint presentations can be added as events to the event script. At this time, the events can be synched to an existing stream.

In the case of a live event, however, the client uses the live event administration feature, described further below, to push events to the end user. The live event administration functionality permits the client to scroll through the HTML files in the event script. At any time, the client can choose to make the file live and broadcast it to the end user. As described below, the min-event or HTML file is then synched to the live event stream. Similarly, the live event administration functionality allows the client to add polling questions to the event and answer end user posted questions during the live event.

The features and functionalities of the web-cast player 500, including the controls described above, are programmed into the processing component 350 of the production software 300 so that the client need only select to include the feature and input certain design attributes, such as a poll question, multiple choice answers, etc. By programming the production software 300 with such functions, the production software 300 can generate unique players 500 for each client without burdening the client with a labor intensive and expensive process. When a new feature is developed it can simply be programmed into the processing component 350, rather than into each individual player. As such, the client can use the development component 310 to update the player to incorporate the new functionality. The generation component 330 of the production software 300 then dynamically generates the updated player.

Web-Cast Player Generation

With reference to FIGS. 2 and 6, as the client proceeds through the design process, the client's selections are received by the web server 206 and stored in the event data structure 600 of the event database 218. Of course, it is to be understood that this process can be done in any number of ways, including providing a “submit” button or capturing the selections as the client moves through the process. Each of the client's selections represent values to be mapped to the design properties 630 that define the user-perceptible attributes 501 of the web-cast player 500. The design properties 630 are preferably stored in a data structure 600 having sub-directories for each particular design property 630. The generation component 330 of the production software 300 utilizes the mapped design properties 630 and client-selected values to generate the web-cast player 500.

With further reference to FIG. 6, there is a schematic of an exemplary embodiment of the hierarchical data structure 600 for use with the present invention. It should be noted that an exemplary set of levels and categories are depicted to illustrate the operation of the generation component. As shown in FIG. 1, the data structure 600 is preferably stored on an event database 218 or other data storage device capable of being accessed by the web server 206. As depicted in FIG. 6, the data structure 600 can store multiple client accounts 605, 605′, which are identified by an “EventSeriesID” 607, 607′. Although not shown, each EventSeriesID 607, 607′ identifies that a particular event and associated values are owned by a particular client. In this way, a client may design multiple events that are linked to the client account 605, 605′. Furthermore, as described above, each event is assigned an “EventID” 609, 609′. The EventID 609, 609′ is associated with all of the design properties and corresponding values for that particular event. The “EventURL” 611, 611′, described further below, is the link or Uniform Resource Locator (“URL”) associated with the event and will be the link that the end user clicks to view the web-cast event. Generally, the eventURL 611, 611′ is a standard “http” url used to launch the event.

With further reference to FIG. 6, there are shown various design properties 630, 630′ that correspond to the user-perceptible attributes of the web-cast player. The design properties 630, 630′ include, but are not limited to, skin data 632, 632′, question manager data 634, 634′, survey data 636, 636′, email reminder data 638, 638′, poll manager data 640, 640′, slide push data 642, 642′, Flash® data 644, 644′, and multi-event data 646, 646′. Some design properties 630, 630′ include various corresponding sub-properties that are mapped to values 650 received from the client. An example of such values 650 are shown in FIG. 6 with respect to the “Skin” property.

By way of example only, the images used to generate the skin (i.e., the look and feel) of the web-cast player 500 are referenced in the data structure 600 by the “SkinDir=“corporate_images”“ design property 632. Thus, the file directory on the event database 218 that stores the skin images is referenced. For instance, the images used for the design property “Skintype=“corporate”“ would be stored in the following directory:

\\studio\images\corporate_images\background\border.gif

Thus, when the generation component 330 of the production software 300 makes a call for the design properties 630 associated with the skin, the “Skintype”, among other associated properties is returned. In the example above, the generation component 330 then looks-up the associated images in the referenced file directories under the “corporate_images” directory to pull all of the images needed to generate the web-cast player 500. As such, by using a standard data structure 600, the server system 200 operates to retrieve the design properties 630, 630′ from the event database 218 and then retrieve the files necessary to generate the user-perceptible attributes 501 of the web-cast player 500 and all of its functionality.

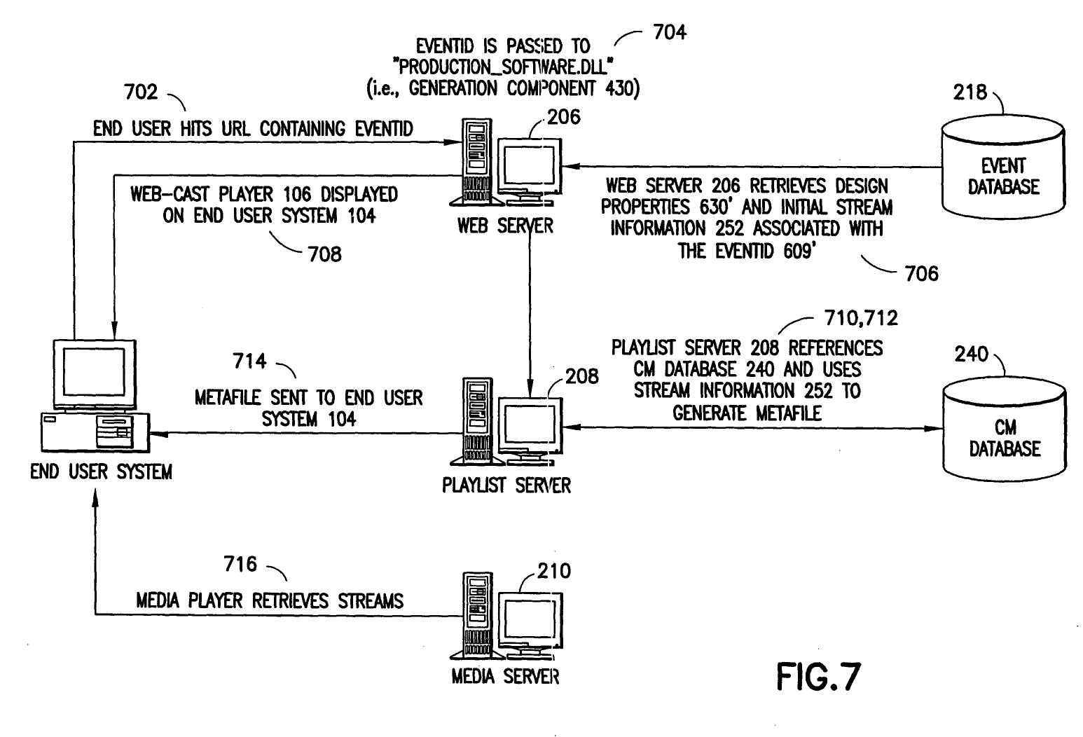

With reference now to FIG. 7, an exemplary embodiment of the process used to generate and deliver the web-cast player 106 using the stored design properties 630, 630′ and values 650 will now be described. Because each of the individual design properties 630, 630′ are associated with a particular EventID 609, 609′, as described above, the group of design properties 630, 630′ can be accessed from the data structure 600 by the generation component 330 to generate the web-cast event.

With reference now to FIG. 7, the generation process is begun when the end user hits a link that contains a particular event id. Step 702. An example of such a link or (URL) is found below:

http://webserver.com/generation.dll?id=XYZ789

When the link is clicked, the EventID 609′ (shown above as “id=XYZ789”) is returned to the generation component 330 of the production software 300. Step 704. The generation component 330 then hits (or accesses) the event database 218 to retrieve all of the stored design properties 630′ associated with the EventID 609′. Step 706. These design properties 630′ are used to populate (or instantiate) the objects of the generation component 330. In other words, the data structure 600 that stores the design properties 630′ stores each data element needed by the generation component 330 to generate the web-cast player 106. Step 708.

In an exemplary embodiment, shown in FIG. 5, the web-cast player 500 is generated within an Internet browser, such as Internet Explorer (shown) or Netscape Navigator. A streaming media window 502, slide window 506, and browser window 510 provide the medium through which the web-cast event's content is delivered. In addition, each of the windows includes various controls 520, 524, 528, and 530 to enable the end user to control such options as controlling the video/audio stream (control 524), enlarging or reducing slide size (control 528), and moving from various web pages (control 530). A logo window 540 displays the logo of the company producing the web-cast or any other advertisement-type image. In the preferred embodiment, the production software utilizes Dynamic HTML (“DHTML”) and Cascading Style Sheet (“CSS”) technologies to deliver the web-cast player 500 to the end user's system 104. DHTML and CSS are preferred because their use gives the web-cast player 500 an application-type look and feel. In other words, the end user feels as though he/she is using a PC-based application, rather than a web page. Of course, one skilled in the art will recognize that any other version or form of HTML, XML, or other mark-up language or other known or hereafter developed language, code, software, or scripting technique can be utilized to deliver the web-cast player 500 to the end user.

With further reference to FIGS. 1 and 2, a preferred embodiment of the process of delivering a live or archived web-cast to the end user will now be described. The media servers 210 are connected to the world wide web, or some other global communications network 150, through the LAN 202. In this respect, streaming content is made available to end user systems 104 through the world wide web 150.

Upon completion of the scheduling and production phase of the web-cast event, a uniform resource locator (URL) or link (shown as EventURL 611 in FIG. 6) is returned to the client system 102 to be embedded in the client's web page. An end user desiring to listen to or view the web-cast on their computer 104 or other device can click on the URL. In the case of an event utilizing a playlist metafile, a content group (“CG”) identifier 244, which is associated with the EventID 609, can be embedded within the URL in place of the EventID 609, as shown below:

<A href=“http://webserver.company.com/startevent.asp?CGid=efg56”>.

The CG Identifier 244 is shown above as “CGid=efg56”. In the illustrative URL shown above, the link points to the web server 206 that will execute the “startevent.asp” program and dynamically generate a playlist metafile. One skilled in the art will recognize from the teachings herein that although the “startevent” application uses Active Server Page (ASP) technology, it is not necessary to use ASP. Rather, any programming or scripting language or technology could be used to provide the desired functionality. It is preferred, however, that the program run on the server side so as to alleviate any processing bottlenecks on the end user side.

The “startevent” program functions to cause the web server 206 to make a call to the client account 241 of the CM database 230 to retrieve the EventID 609 associated with the embedded CG id 244. Using the CG id 244, the web server 206 looks in the CG table 242, which in turn includes the EventID 609 and points to the associated CG streams table 246. As shown in FIG. 2, the CG streams table 246 contains the individual stream ids 248 and their respective sort orders. The web server 206 also calls to the event database 218 to capture the design properties 630 associated with the EventID 609.

The stream ids 248 and the sort order are returned to a “makeplaylist” function of the “startevent” program which then makes a call to the streams2 table 250 in the CM database 230 that contain data 252 associated with the individual streams. Namely, the streams2 table 250 includes a URL prefix and a stream filename. The individual stream ids 248 are also used by the “makeplaylist” function to call to the stream-servers table 254 in the CM database 230. The streams 2 table 250 includes data 252 such as the location or hostname of the particular media server 210 containing the stream file associated with a particular stream identifier. Using the URL prefix, the hostname, and the stream filename, the “makeplaylist” function dynamically generates a URL for each stream file. An example of such a URL is listed below:

mms://mediaserver.company.com/filename.asf

The URL prefix is shown above as “mms://” which indicates that the stream file will be transferred using the Microsoft Metadirectory Service. One skilled in the art will recognize that any equivalent protocol could be utilized. The hostname is shown above as “mediaserver.company.com” which indicates the DNS address for the IP address of the stream file on the media server 210. The stream filename, shown above as “filename.asf”, points to the actual stream to be delivered to the player 500.

Thus, referring again to FIG. 7, the web server 206 also retrieves initial stream information, such as the CG id associated with the eventID 609 embedded in the eventURL 611, from the event database 218. Step 706. Further, the playlist server 208 references the CM database 240 to retrieve the stream ids 248 and associated stream information 252. Step 710. Then, using the individual stream ids and associated URLs, the “makeplaylist” function then dynamically generates a metafile to be passed to the media player stored on the end user's computer 104. Step 712. It should be noted that in FIG. 7 a separate playlist server generates the playlist metafile that is passed to the end user system 104. However, one skilled in the art will recognize that the same functionality can be performed on the web server 206 or any other combination of servers. An example of a metafile for use with Windows Media Technologies is shown below:

<ASX>

<ENTRY>

<REF

HREF=“mms://mediaserver.company.com/stream1.asf”>

<REF

HREF=“mms://mediaserver.company.com/stream2.asf”>

<REF

HREF=“mms://mediaserver.company.com/stream3.asf”>

</ENTRY>

</ASX>

One skilled in the art will recognize, of course, that different media technologies utilize different formats of metafiles and, therefore, the term “metafile” is not limited to the ASX-type metafile shown above. The metafile is passed to the end user system 104. Step 714. Lastly, the end user's media player pulls each identified stream file from the media server 210 identified in the metafile in the order in which it appears in the metafile. Step 716.

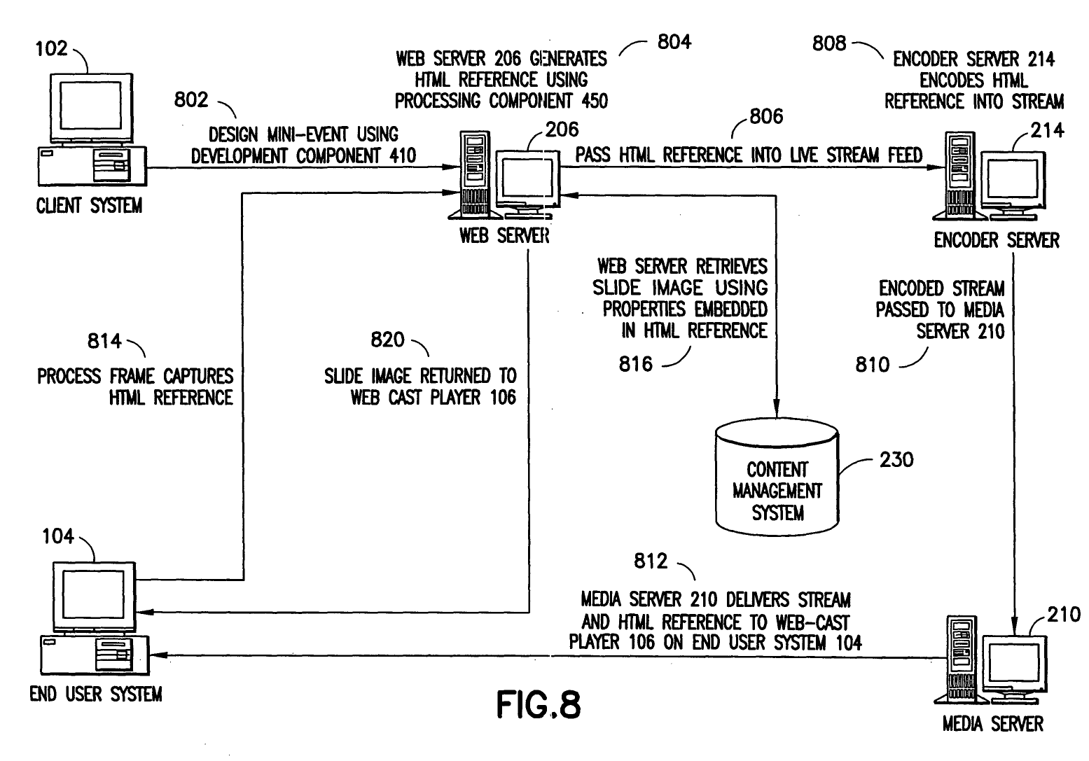

Turning now to FIG. 8, an exemplary embodiment of the operation of the processing component 350 to allow the client to incorporate various media content into the web-cast event while it is running live is shown. The exemplary embodiment is described herein in connection with the incorporation of slide images that are pushed during the live event to the web-cast player 106. It should be understood, however, that any type of media content or other interactive feature could be incorporated into the web-cast in this manner.

With reference again to FIG. 5, the web-cast player 500 is preferably included with a frame hidden from the view of the end user. This frame (not shown in FIG. 5) preferably calls an ASP script on the web server 206.

Referring again to FIG. 8, the client accesses the live event administration functionality of the development component 310 of the production software 300 to design a mini-event to include in the live web-cast event. Step 802. With further reference to FIG. 9, the client would simply select (or click) the “Live Event Administration” button to access the functionality. The development component 310 then generates an HTML reference file on the web server 206. Step 804. The HTML reference contains various properties of the content that is to be pushed to the web-cast player 106. For instance, the HTML reference includes, but is not limited to, a name identifier, a type identifier, and a location identifier. Below is an exemplary HTML reference:

http://webserver.co.com/process.asp?iProcess=2&contentloc=“&sDatawindow&”&name=“&request.form(“url”)

The “iProcess” parameter instructs the “process” program how to handle the incoming event. The “contentloc” parameter sets the particular data window to send the event. And, the “name” parameter instructs the program as to the URL that points to the event content. As described above, during event preparation, the client creates the event script which is published to create an HTML file for each piece of content. The HTML reference is a URL that points to the URL associated with the HTML file created for the pushed content.

The web server 206 then passes the HTML reference to the live feed coming into the encoder server 214. Step 806. The HTML reference file is then encoded into the stream as an event. Step 808. In this way, the HTML reference file becomes a permanent event in the streaming file and the associated content will be automatically delivered if the stream file is played from an archived database. This encoding process also synchronizes the delivery of the content to a particular time stamp in the streaming media file. For example, if a series of slides are pushed to the end user at different intervals of the stream, this push order is saved along with the archived stream file. Thus, the slides are synchronized to the stream. These event times are recorded and can be modified using the development tool to change an archived stream. The client can later reorder slides.

The encoded stream is then passed to the media server 210. Step 810. Preferably, the HTML reference generated by the development component 410 is targeted for the hidden frame of the web-cast player 106. Of course, one skilled in the art will recognize that the target frame need not be hidden so long as the functionality described below can be called from the target frame. As shown above, embedded within the HTML reference is a URL calling a “process” function and various properties. When the embedded properties are received by the ASP script, the ASP script uses the embedded properties to retrieve the content or image from the appropriate location on the content management system 230 and push the content to the end user's web-cast player in the appropriate location.

Next, the media server 812 delivers the stream and HTML reference to the web-cast player 106 on the end user system 104. Step 812. The targeted frame captures and processes the HTML reference properties. Step 814.

In the exemplary embodiment, the name identifier identifies the name and location of the content. In an alternate example, the “process.asp” program accesses (or “hits”) the CM database 240 to return the slide image named “slide1” to the web-cast player 106 in appropriate player window 502, 506, 510, although this is not necessary. Step 816. The type identifier identifies the type of content that is to be pushed, e.g., a poll or a slide, etc. In the above example, the type identifier indicates that the content to be pushed is a JPEG file. The location identifier identifies the particular frame, window, or layer in the web-cast player that the content is to be delivered. In the above example, the location identifier “2” is associated with an embedded slide window, such as window 506 shown in FIG. 5.

The content is then returned to the web-cast player 106 in the appropriate window. Step 820.

By way of further example only, an HTML web page or flash presentation could be pushed to browser window 510. By way of further example, an answer to a question communicated by an end user could be pushed as an HTML document to a CSS layer that is moved to the front of the web-cast player by the “process.asp” function.

In this way, the client can encode any event into the web-cast in real-time during a live event. Because the target frame functions to interpret the embedded properties in the HTML reference—rather than simply sending the content to a frame, the content is seamlessly incorporated into the web-cast player 106 using the particular skin theme selected for that web-cast. This process gives the web-cast player 106 the application-type feel described above.

Corporate Television Embodiment

In addition, as mentioned above, using the channel component 318 of the development component 310, the client can modify and update existing, archived web-casts. In particular, the client can reorder the synchronization of slides and other events that were encoded into the stream file. In an exemplary embodiment, the channel component 318 includes indexing functionality to allow the client to change the timing and sequence of events.

Further, through the channel component 318, the client is provided functionality to create channels using clips of existing streams. The client can add various streams to a “playlist” which is assigned a playlist id (indicated above as the CG Identifier). The CG id is then associated with the stream ids for each stream added to the playlist. For example, the client can choose to add highlight clips from various recent corporate seminars that were web-cast. Using the channel component 318, the client selects various streams and sets a start and end time for each stream. As shown in FIG. 2, the start and end times 252 of the clip are associated with the stream id and stored in the streams2 table 250. When the stream is passed to the end user's media player, the media player begins the stream at the start time and ends at the end time. Yet further, the client can set an expiration date for the streaming content. In this way, an outdated link will not activate a web-cast in which the stream file has expired.

A playlist may also include one or more clips of various streams. For example, a clip id can be assigned by the content management system 230 to a clip created by the client through the channel component 318, as described above. With further reference to FIG. 2, the clip id (not shown) can be stored in the content management database 240 and associated with both an event id 609 and CG id 244. As shown in FIG. 2, a stream_clips table 256 may be included that stores and associates a clip id with a stream id and associated clip title, start time, and end time of the clip. It should be noted that a stream may be associated with one or more streams.

Reporting Functionality

The functionality of the reporting component 370 of the production software 300 will now be described. The reporting component 370 generally functions to collect data from end users and track end user use of the web-cast event and player. Through the reporting component 370, the client can track the number of end users viewing the event and how long they watched. The reporting component 370 also captures the interaction with the end users as it collects all of the questions asked and answered and the result of polling questions. In this way, all of the end user's interaction with the web-cast event is recorded and stored for the client's reporting needs. The client can, therefore, manage the success of the web-cast event.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention.

I claim:

1. A method for permitting the development of an event by a client, the method comprising:
a) displaying a development interface on a client computer;
b) receiving scheduling information for the event from the client;
c) receiving one or more selections of user-perceptible attributes of a player for use with the event from the client;
d) receiving content uploaded from the client computer for use with the event;
e) receiving an indication from the client to identify a type of streaming media for use with the event; and
f) receiving an indication from the client to include one or more functional features in the event.

2. The method of claim 1, wherein the client can design the event using either a freeform approach or a wizard approach.

3. The method of claim 1, wherein step (b) comprises receiving at least a title for the event, a link to the event, and a date when the event will occur.

4. The method of claim 3, wherein the link is a uniform resource locator.

5. The method of claim 1, wherein the user-perceptible attributes comprise a player structure and a player skin, and step (c) comprises:
receiving a selection of the player structure from the client; and
receiving a selection of the player skin from the client.

6. The method of claim 5, wherein the player structure comprises at least a streaming media window.

7. The method of claim 5, wherein the player structure comprises at least an image window.

8. The method of claim 7, wherein the image window displays slides.

9. The method of claim 5, wherein the player structure comprises at least a browser window.

10. The method of claim 5, wherein the player structure comprises controls to run the player.

11. The method of claim 5, wherein the player skin defines a graphical look of the player.

12. The method of claim 11, wherein the player skin is defined by a theme.

13. The method of claim 12, wherein the theme comprises a plurality of images positioned so as to define the graphical look of the player.

14. The method of claim 12, wherein the theme comprises a plurality of colors.

15. The method of claim 1, wherein a directory on a centralized, content management system is associated with the client and the method further comprises:
storing the scheduling information in the directory;
storing the selections of the user-perceptible attributes in the directory;
storing the content uploaded from the client computer in the directory;
storing the type of streaming media in the directory; and
storing the indication of the functional features in the directory.

16. The method of claim 1, wherein the type of steaming media is a live video feed.

17. The method of claim 1, wherein the type of steaming media is a live telephony feed.

18. The method of claim 1, wherein the type of steaming media is a live audio feed.

19. The method of claim 1, wherein the type of steaming media is pre-encoded media.

20. The method of claim 1, wherein the functional feature indicated by the client is an animated graphics display.

21. The method of claim 1, wherein the functional feature indicated by the client is a slide display.

22. The method of claim 1, wherein the functional feature indicated by the client is a registration form.

23. The method of claim 1, wherein the functional feature indicated by the client is a poll.

24. The method of claim 1, wherein the functional feature indicated by the client is a questionnaire.

25. The method of claim 1, wherein the functional feature indicated by the client is a survey.

26. A method of designing and controlling a web-cast event, the method comprising:
(a) prompting a client to input information related to user-perceptible attributes of the web-cast event;
(b) storing the information in an event directory associated with the client;
(c) generating a web-cast player to be displayed on a computer device of the end user using the stored information in response to a request from the end user to receive the web-cast event;
(d) streaming a media feed through a media window in the web-cast player; and
(e) delivering content through a content window in the web-cast player.

27. The method of claim 26, wherein the media feed is live.

28. The method of claim 26, wherein the media feed is archived.

29. The method of claim 26, wherein the media window is embedded in the web-cast player.

30. The method of claim 26, wherein the content window is an image window and the content is an image.

31. The method of claim 26, wherein the content window is a browser window and the content is a web page.

32. The method of claim 26, wherein the request comprises the end user clicking a link having an event identifier embedded therein and step (c) further comprises:
accessing the event directory associated with the event identifier;
retrieving the stored user-perceptible attributes; and
populating generation software with design properties associated with the stored user-perceptible attributes.

33. The method of claim 32, wherein the generation software uses a dynamic hypertext mark-up language to generate the web-cast player.

34. The method of claim 32, wherein the generation software uses a cascading style sheet technology to generate the web-cast player.

35. The method of claim 32, wherein the event identifier is associated with a stream identifier and step (d) further comprises:
accessing the event directory associated with the event identifier;
retrieving the one or more streams associated with the stream identifier; and deliver the stream to the media window in the web-cast player.

36. The method of claim 32, further comprising arranging the one or more streams into a playlist.

37. The method of claim 26, further comprising:
prompting the client to select content to be pushed to the web-cast player;
generating a reference file comprising properties of the selected content;
passing the reference file to the media feed;
encoding the reference file into the media feed; and
updating the web-cast player based upon the properties stored in the reference file.

38. The method of claim 37, wherein the properties comprise a name identifier, a type identifier, and a location identifier.

39. The method of claim 38, wherein the name identifier points to the selected content.

40. The method of claim 38, wherein the type identifier indicates characteristics of the selected content.

41. The method of claim 38, wherein the location identifier indicates a location in the web-cast player to include the selected content.

42. The method of claim 41, wherein the selected content is an image and the location identifier indicates an image window.

43. The method of claim 41, wherein the selected content is a web page and the location identifier indicates a browser window.

44. The method of claim 37, wherein the web-cast player is updated in real-time.

45. A system for the design and administration of a web-cast event, the system comprising:
a centralized, server system interconnected via a public network to one or more clients and end users;
a development component stored on the server system for prompting the clients to select user-perceptible attributes of a player and to upload content associated with the web-cast event;
a generation component stored on the server system for generating the player and communicating the content to end users; and
a live event administration component stored on the server system for allowing the client to administer the web-cast event.

46. The system of claim 45, wherein the development component displays a graphical interface on a computer of the client.

47. The system of claim 45, wherein the user-perceptible attribute is a structure of the player.

48. The system of claim 45, wherein the user-perceptible attribute is a skin of the player.

49. The system of claim 45, wherein the user-perceptible attribute is a functional feature to be included in the player.

50. The system of claim 45, further comprising an interaction component for enabling the end user to interact with the web-cast event.

51. The system of claim 50, wherein the interaction component enables one or more of the end users to answer a question.

52. The system of claim 51, wherein the interaction component returns results to the end users.

53. The system of claim 45, wherein the server system is operative with the live event administration component to:
receive an instruction from the client to push content;
generate a reference including information for the content;
encode the reference in a media stream being delivered to the player; and
update the player using the reference.
